(19) United States
(12) Patent Application Publication
(10) Pub. No.: US 2022/0043510 A1
(43) Pub. Date: Feb. 10, 2022

(54) WEARABLE EYE-TRACKING SYSTEM

(71) Applicant: Ganzin Technology, Inc., TAIPEI CITY (TW)

(72) Inventors: LIANG FANG, Taipei City (TW); Shao-Yi Chien, Taipei City (TW)

(21) Appl. No.: 17/177,210

(22) Filed: Feb. 17, 2021

(30) Foreign Application Priority Data
Aug. 10, 2020 (TW) 109127042

(51) Int. Cl. G06F 3/01; G02B 27/01; G02B 27/00; G06T 7/246

(52) U.S. Cl. CPC G06F 3/013; G02B 27/0172; G06T 2207/30041; G06T 7/246; G02B 27/0093

(57) ABSTRACT

An eye-tracking system includes a light-transmitting display module, a reflecting mirror, an image system, and a processing unit. The light-transmitting display module includes a first side and a second side. The imaging system is disposed on the second side of the light-transmitting display module and includes a camera lens and an image sensor. The camera lens is coated with an optical film for receiving the light reflected by a user face. The image sensor is configured to provide an eye image based on the light reflected by the user face. The processing unit is configured to analyze the eye image so as to acquire the facial characteristics associated with the eyes of the user, wherein the user face is located on the first side of the light-transmitting display module when the user puts on the eye-tracking system.

### CROSS REFERENCE TO RELATED APPLICATION

This application claims priority of Taiwan Application No. 109127042 filed on 2020 Aug. 10.

### BACKGROUND OF THE INVENTION

### 1. Field of the Invention

The present invention is related to a wearable eye-tracking system, and more particularly, to a wearable eye-tracking system with wide viewing range.

### 2. Description of the Prior Art

Virtual reality (VR) is an interactive computer-generated experience taking place within a simulated environment, that incorporates mainly auditory and visual, but also other types of sensory feedback like haptic. Augmented reality (AR) provides an interactive experience of a real-world environment where the objects that reside in the real world are enhanced by computer-generated perceptual information. Mixed reality (MR) is the merging of real and virtual worlds to produce new environments and visualizations, where physical and digital objects co-exist and interact in real time. Most of existing VR/AR/MR applications are controlled by user hands using joysticks or touch screens, but the burden of carry these control devices may cause inconvenience. By incorporating eye-tracking capabilities into VR/AR/MR headsets, the user can use the eyes as an operational interface, wherein various visual elements can trigger certain responses and behaviors.

One prior art method of incorporating eye-tracking capabilities into in VR/AR/MR applications typically includes the use of an Infrared (IR) light source, a display module, an imaging system and a processing unit. The imaging system is disposed beside the display module. When the IR light source illuminates the face of a user, the imaging system may capture user facial images which include multiple light spots reflected by user eyes. The processing unit may then acquire the eye-movement and gaze point of the user by analyzing the user facial images. However, this prior art method requires a large angle of shot and may fail to acquire accurate user facial images.

Another prior art method of incorporating eye-tracking capabilities into VR/AR/MR applications further includes the use of an optical device, such as a hot mirror. The optical device is configured to change the path of light within a predetermined spectrum range, i.e., direct the light within the predetermined spectrum range towards the imaging system. In this prior art structure, the imaging system is disposed at a location which does not obstruct user sight, and may capture user facial images based on the reflected light within the predetermined spectrum range. The processing unit may then acquire the eye-movement and gaze point of the user by analyzing the user facial images. However, this prior art method requires extra space to accommodate the optical device and is difficult to implement in a compact head-mounted display (HMD) with short eye relief or in a near-eye display module.

### SUMMARY OF THE INVENTION

The present invention provides an eye-tracking system which includes a light-transmitting display module having a first side and a second side, an imaging system, and a processing unit. The imaging system is disposed on the second side of the light-transmitting display module and includes a camera lens and an image sensor. The camera lens is coated with an optical film for receiving light reflected by a face of a user. The image sensor is configured to provide an eye image based on the light reflected by the face of the user. The processing unit is configured to acquire ocular characteristic information of the user by analyzing the eye image, wherein the face of the user is located on the first side of the light-transmitting display module when the user puts on the eye-tracking system.

The present invention also provides an eye-tracking system which includes a light-transmitting, a reflecting mirror, an imaging system and a processing unit. The light-transmitting display module is disposed on a first imaging optical path and includes a first side and a second side. The reflecting mirror is disposed on the second side of the light-transmitting display module and configured to receive light which travels along a second imaging optical path after reflected by a face of a user and direct the light reflected by the face of the user to travel along the first imaging optical path. The imaging system is disposed on the first imaging optical path and located on the first side of the light-transmitting display module and configured to provide an eye image based on the light reflected by the face of the user. The processing unit is configured to acquire ocular characteristic information of the user by analyzing the eye image.

The present invention also provides an eye-tracking system which includes a reflecting mirror, a light-transmitting, an imaging system and a processing unit. The reflecting mirror is configured to receive light which travels along a first imaging optical path after reflected by a face of a user, transmit a part of the light reflected by the face of the user, and direct another part of the light reflected by the face of the user to travel along a second imaging optical path. The light-transmitting display module is disposed on the second imaging optical path. The imaging system is disposed on a backside of the reflecting mirror and located on an extended path of the first imaging optical path, or on a plane with a depth substantially equal to a depth of the light-transmitting display module and configured to provide an eye image based on the light reflected by the face of the user. The processing unit is configured to acquire ocular characteristic information of the user by analyzing the eye image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional diagram illustrating a wearable eye-tracking system for VR applications according to an embodiment of the present invention.

FIG. 2 is a functional diagram illustrating a wearable eye-tracking system for VR applications according to an embodiment of the present invention.

FIG. 3A is a functional diagrams illustrating a wearable eye-tracking system for AR/MR applications according to an embodiment of the present invention.

FIG. 3B is a functional diagrams illustrating a wearable eye-tracking system for AR/MR applications according to an embodiment of the present invention.

FIG. 4 is a functional diagram illustrating a wearable eye-tracking system for AR/MR applications according to an embodiment of the present invention.

FIG. 5 is a functional diagram illustrating a wearable eye-tracking system for AR/MR applications according to an embodiment of the present invention.

FIG. 6A is a functional diagram illustrating a wearable eye-tracking system for AR/MR applications according to an embodiment of the present invention.

FIG. 6B is a functional diagram illustrating a wearable eye-tracking system for AR/MR applications according to an embodiment of the present invention.

### DETAILED DESCRIPTION

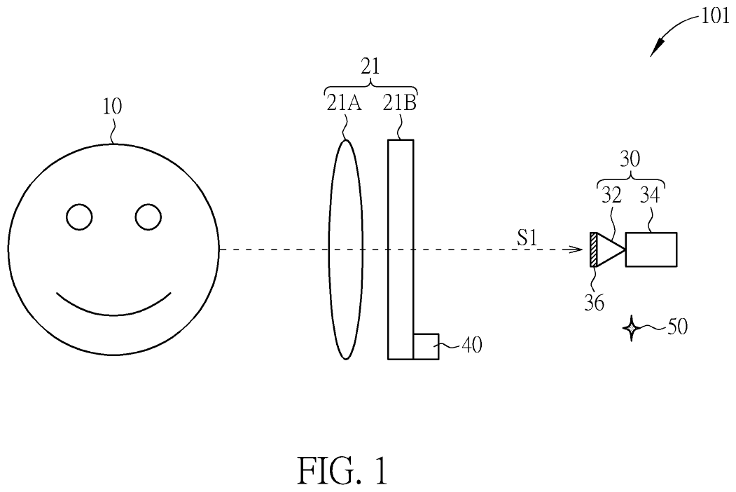

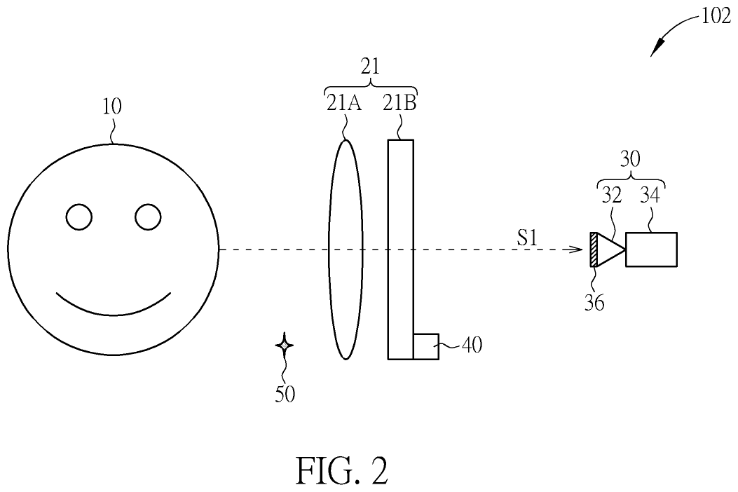

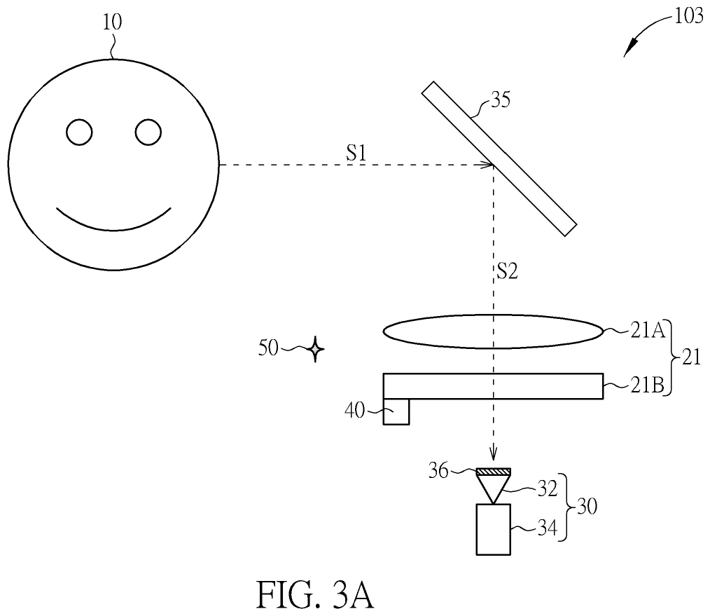

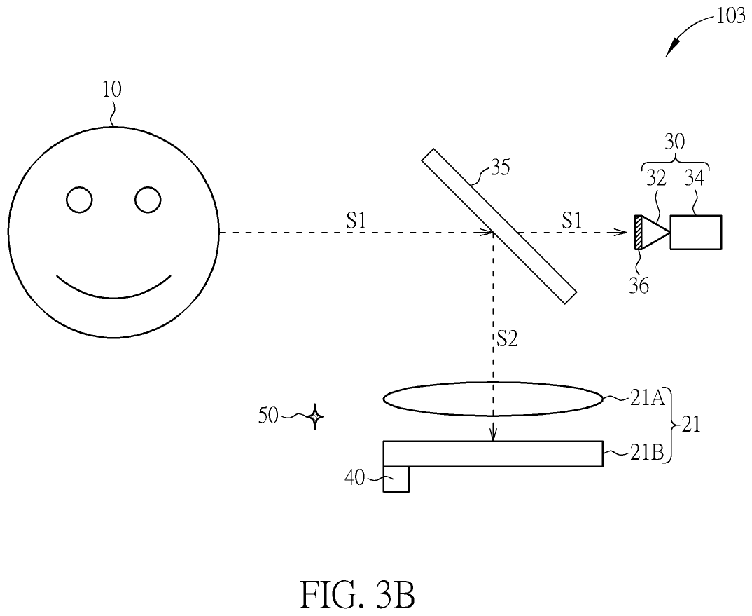

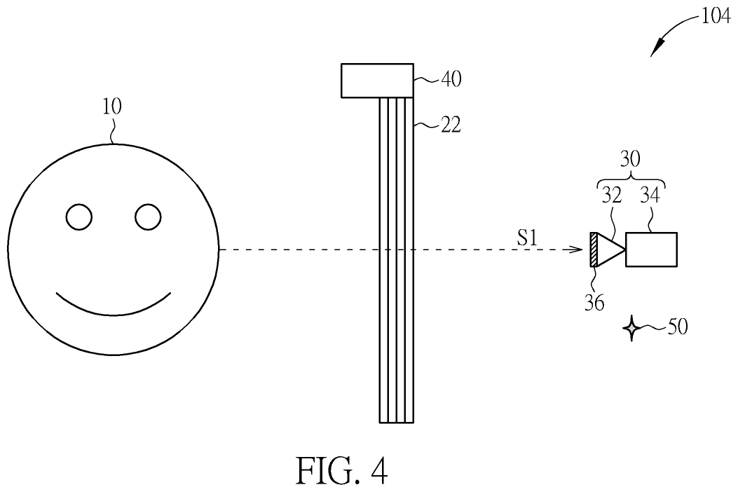

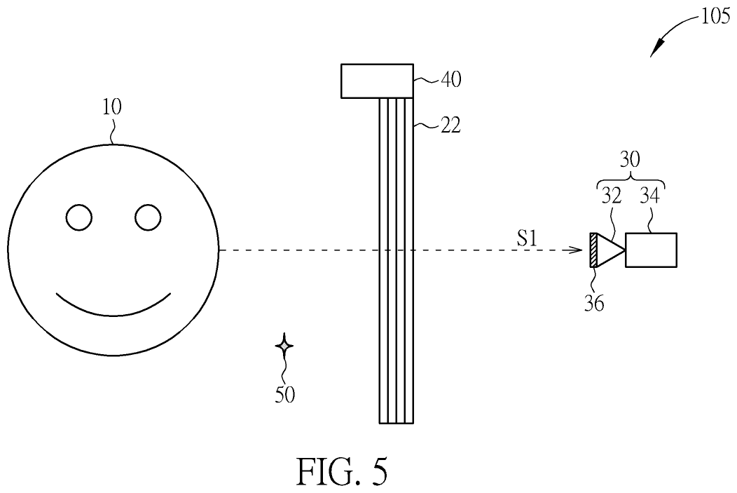

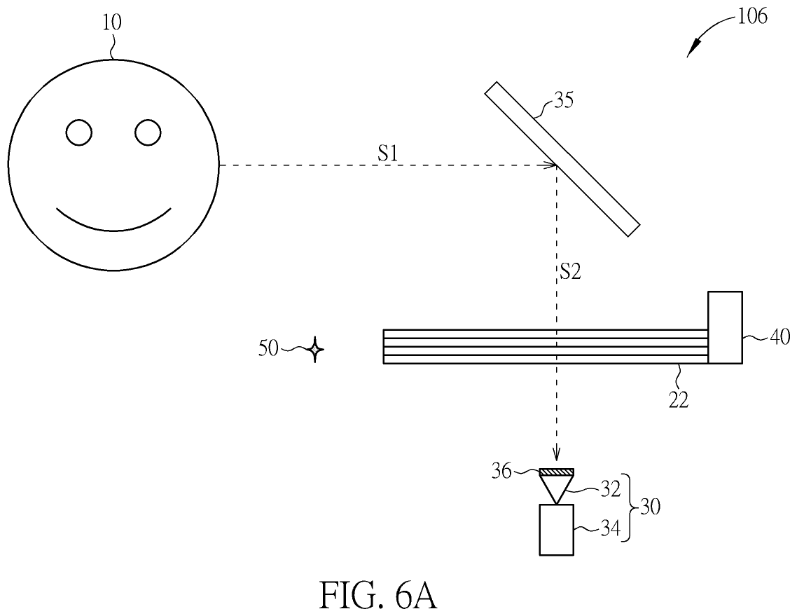

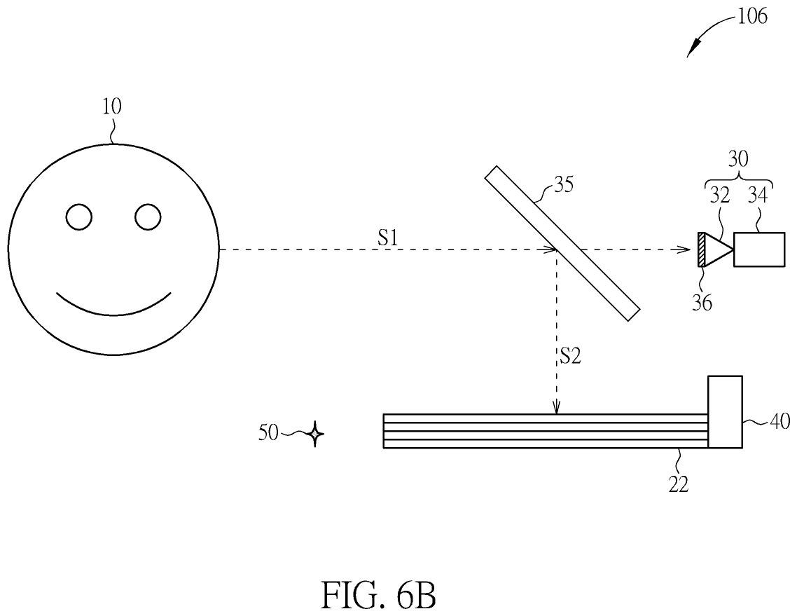

FIG. 1 is a functional diagram illustrating a wearable eye-tracking system 101 for VR applications according to an embodiment of the present invention. FIG. 2 is a functional diagram illustrating a wearable eye-tracking system 102 for VR applications according to an embodiment of the present invention. FIGS. 3A and 3B are functional diagrams illustrating a wearable eye-tracking system 103 for AR/MR applications according to embodiments of the present invention. FIG. 4 is a functional diagram illustrating a wearable eye-tracking system 104 for AR/MR applications according to an embodiment of the present invention. FIG. 5 is a functional diagram illustrating a wearable eye-tracking system 105 for AR/MR applications according to an embodiment of the present invention. FIGS. 6A and 6B are functional diagrams illustrating a wearable eye-tracking system 106 for AR/MR applications according to embodiments of the present invention.

In the embodiments depicted in FIGS. 1 and 2, each of the eye-tracking systems 101 and 102 includes a light-transmitting display module 21, an imaging system 30, a processing unit 40, and a light source 50. The light-transmitting display module 21 includes a lens 21A and a micro display panel 21B. The lens 21A is configured to enlarge near-eye real images provided by the micro display panel 21B for forming virtual images on the retina of a user 10, thereby providing a virtual panoramic space. The eye-tracking systems 101 and 102 adopt a single imaging optical path design. After the user 10 puts on the eye-tracking system 101 or 102, the face of the user 10 and the imaging system 30 are located on opposite sides of the light-transmitting display module 21 at corresponding positions. Therefore, the light reflected by the face of the user 10 may pass the light-transmitting display module 21 and arrive at the imaging system 30 by traveling along a single imaging optical path (represented by an arrow S1). In another embodiment, the light-transmitting display module 21 may include a plurality of lens 21A and a micro display panel 21B. The light arriving at the light-transmitting display module 21 along the imaging optical path S1 may encounter several reflections or refractions by the plurality of lens 21A, and then exit the light-transmitting display module 21A along the imaging optical path S1. However, the number of lenses in the light-transmitting display module 21 does not limit the scope of the present invention.

In the embodiments depicted in FIGS. 3A and 3B, the eye-tracking system 103 includes a light-transmitting display module 21, an imaging system 30, a reflecting mirror 35, a processing unit 40, and a light source 50. The light-transmitting display module 21 includes a lens 21A and a micro display panel 21B. The lens 21A is configured to enlarge near-eye real images provided by the micro display panel 21B for forming virtual images on the retina of a user 10, thereby providing a virtual panoramic space. The reflecting mirror 35 may be a mirror or a lens with a half freeform surface. However, the implementation of the reflecting mirror 35 does not limit the scope of the present invention.

In the embodiment depicted in FIG. 3A, the eye-tracking system 103 adopts a reflection imaging optical path design. After the user 10 puts on the eye-tracking system 103, the reflecting mirror 35 and the imaging system 30 are located on opposite sides of the light-transmitting display module 21 at corresponding positions. Therefore, the light reflected by the face of the user 10 may arrive at the reflecting mirror 35 by traveling along a first imaging optical path (represented by an arrow S1), be directed by the reflecting mirror 35 to travel along a second imaging optical path (represented by an arrow S2), and arrive at the imaging system 30. In another embodiment, the imaging system 30 may be located at a plane having a depth substantially equal to that of the light-transmitting display module 21. For example, the imaging system 30 may be located on the lateral side of the light-transmitting display module 21.

In the embodiment depicted in FIG. 3B, after the user 10 puts on the eye-tracking system 103, the face of the user 10 and the imaging system 30 are located on opposite sides of the reflecting mirror 35 at corresponding positions. Therefore, the light reflected by the face of the user 10 may arrive at the reflecting mirror 35 by traveling along the first imaging optical path S1. Then, the light which satisfies a predetermined optical condition can pass the reflecting mirror 35 and continues to travel along an extended path associated with the first imaging optical path S1. Meanwhile, the light which does not satisfy the predetermined optical condition is directed by the reflecting mirror 35 to travel along the second imaging optical path S2. In this embodiment, the predetermined optical condition may refer to a predetermined wavelength range, or a predetermined percentage of the amount of light arriving at the reflecting mirror 35.

In the embodiments depicted in FIGS. 4 and 5, each of the eye-tracking systems 104 and 105 includes a light-transmitting display module 22, an imaging system 30, a processing unit 40, and a light source 50. The light-transmitting display module 22 may be an optical combiner with a multi-layered structure for combining the virtual information with the real world scene. The eye-tracking systems 104 and 105 adopt a single imaging optical path design. After a user 10 puts on the eye-tracking system 104 or 105, the face of the user 10 and the imaging system 30 are located on opposite sides of the light-transmitting display module 22 at corresponding positions. Therefore, the light reflected by the face of the user 10 may pass the light-transmitting display module 22 and arrive at the imaging system 30 by traveling along a single imaging optical path (represented by an arrow S1).

In the embodiments depicted in FIGS. 6A and 6B, the eye-tracking system 106 includes a light-transmitting display module 22, an imaging system 30, a light-transmitting reflecting mirror 35, a processing unit 40, and a light source 50. The light-transmitting display module 22 may be an optical combiner with a multi-layered structure for combining the virtual information with the real world scene. The reflecting mirror 35 may be a mirror or a lens with a half freeform surface. However, the implementation of the reflecting mirror 35 does not limit the scope of the present invention.

In the embodiment depicted in FIG. 6A, the eye-tracking system 106 adopts a reflection imaging optical path design. After the user 10 puts on the eye-tracking system 106, the reflecting mirror 35 and the imaging system 30 are located on opposite sides of the light-transmitting display module 2 at corresponding positions. Therefore, the light reflected by the face of the user 10 may arrive at the reflecting mirror 35 by traveling along a first imaging optical path (represented by an arrow S1), be directed by the reflecting mirror 35 to travel along a second imaging optical path (represented by an arrow S2), and arrive at the imaging system 30. In another embodiment, the imaging system 30 may be located at a plane having a depth substantially equal to that of the light-transmitting display module 22. For example, the imaging system 30 may be located on the lateral side of the light-transmitting display module 22.

In the embodiment depicted in FIG. 6B, after the user 10 puts on the eye-tracking system 106, the face of the user 10 and the imaging system 30 are located on opposite sides of the reflecting mirror 35 at corresponding positions. Therefore, the light reflected by the face of the user 10 may arrive at the reflecting mirror 35 by traveling along the first imaging optical path S1. Then, the light which satisfies a predetermined optical condition can pass the reflecting mirror 35 and continues to travel along an extended path associated with the first imaging optical path S1. Meanwhile, the light which does not satisfy the predetermined optical condition is directed by the reflecting mirror 35 to travel along the second imaging optical path S2. In this embodiment, the predetermined optical condition may refer to a predetermined wavelength range, or a predetermined percentage of the amount of light arriving at the reflecting mirror 35.

In the eye-tracking systems 101-106, the imaging system 30 includes a camera lens 32 and an image sensor 34. The imaging system 30 may provide eye images of the user 10 based on the light reflected by the face of the user 10. The image sensor 34 may adopt a charge coupled device (CCD), a complementary metal-oxide semiconductor (CMOS), or another device providing similar function. The image sensor 34 may convert the detected optical signals into analog signals and perform analog-to-digital conversion and color adjustment on the analog signals for providing digitized image data. In an embodiment, the camera lens 32 and the image sensor 34 are separately disposed in the imaging system 30. In another embodiment, the camera lens 32 may be directly fabricated on the image sensor 34 in a semiconductor process. However, the type and fabrication of the image sensor 34 do not limit the scope of the present invention.

After the user 10 puts on the eye-tracking systems 101-106, the light source 50 may illuminate the face of the user 10. In the eye-tracking systems 101 and 104, the light source 50 and the imaging system 30 are located on one side of the corresponding display module, and the face of the user 10 is located on another side of the corresponding display module, which means the light source 50 is closer to the imaging system 30 than to the face of the user 10. In the eye-tracking systems 102 and 105, the light source 50 and the face of the user 10 are located on one side of the corresponding display module, and the imaging system 30 is located on another side of the corresponding display module, which means the light source 50 is closer to the face of the user 10 than to the imaging system 30. In the eye-tracking systems 103 and 106, the light source 50 may be disposed on any location suitable for illuminating the face of the user 10. The light source 50 may include one or multiple light emitting diodes (LEDs). The eye-tracking systems 101-105 may turn on/off the light source 50 or adjust the brightness of the light source 50 according to the ambient light. However, the disposition location and the type of the light source 50 do not limit the scope of the present invention.

In the eye-tracking systems 101-106, the camera lens 32 in the imaging system 30 may be coated with an optical film 36 which provides a cut filtering function or a band-pass filtering function, thereby improving the image quality of the image sensor 34.

The processing unit 40 is configured to analyze the eye image provided by the imaging system 30 so as to acquire ocular characteristic information of the user. The ocular characteristic information may include the line of sight, the blink rate, the completeness of blinking, the iris status or the pupil size of the user, and other information capable of identifying the identity or the mental state of the user 10. Based on the ocular characteristic information, the eye-gaze location, the eye movement and the facial image of the user 10 may be acquired. In an embodiment of the present invention, the processing unit 40 may be an application-specific integrated circuit (ASIC) chip, a field programmable gate array (PGA), an accelerated processing unit (APU) or a central processing unit (CPU). However, the implementation of the processing unit 40 does not limit the scope of the present invention.

In conclusion, in the wearable eye-tracking system of the present invention, the imaging system is disposed opposite to the face of the user through the light-transmitting display module, or disposed on the reflection imaging path, thereby capable of providing eye-tracking function with wide viewing range.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An eye-tracking system, comprising:
a light-transmitting display module comprising a first side and a second side;
an imaging system disposed on the second side of the light-transmitting display module and comprising:
a camera lens coated with an optical film for receiving light reflected by a face of a user; and
an image sensor configured to provide an eye image based on the light reflected by the face of the user; and
a processing unit configured to acquire ocular characteristic information of the user by analyzing the eye image, wherein the face of the user is located on the first side of the light-transmitting display module when the user puts on the eye-tracking system.

2. The eye-tracking system according to claim 1, wherein the light-transmitting display module comprises:
a micro display panel for providing a near-eye real image; and
a lens configured to form a virtual image by enlarging the near-eye image so as to provide a virtual panoramic space.

3. The eye-tracking system according to claim 1, wherein the light-transmitting display module comprises an optical combiner.

4. The eye-tracking system according to claim 1, wherein the ocular characteristic information includes a line of sight, a blink rate, a completeness of blinking, an iris status or a pupil size of the user.

5. The eye-tracking system according to claim 1, wherein the optical film provides a cut filtering function or a band-pass filtering function.

6. The eye-tracking system according to claim 1, further comprising a light source disposed on the first side or the second side of the light-transmitting display module for illuminating the face of the user.

7. An eye-tracking system, comprising:
a light-transmitting display module disposed on a first imaging optical path and comprising a first side and a second side;
a reflecting mirror disposed on the second side of the light-transmitting display module and configured to:
receive light which travels along a second imaging optical path after reflected by a face of a user and; and
direct the light reflected by the face of the user to travel along the first imaging optical path;
an imaging system disposed on the first imaging optical path and located on the first side of the light-transmitting display module and configured to provide an eye image based on the light reflected by the face of the user; and
a processing unit configured to acquire ocular characteristic information of the user by analyzing the eye image.

8. The eye-tracking system according to claim 7, wherein the light-transmitting display module comprises:
a micro display panel for providing a near-eye image; and
a lens configured to form a virtual image by enlarging the near-eye image so as to provide a virtual panoramic space.

9. The eye-tracking system according to claim 7, wherein the light-transmitting display module comprises an optical combiner.

10. The eye-tracking system according to claim 7, wherein the ocular characteristic information includes a line of sight, a blink rate, a completeness of blinking, an iris status or a pupil size of the user.

11. The eye-tracking system according to claim 7, wherein the imaging system comprises:
a camera lens coated with an optical film for receiving the light reflected by the face of the user; and
an image sensor configured to provide an eye image based on the light reflected by the face of the user.

12. The eye-tracking system according to claim 11, wherein the optical film provides a cut filtering function or a band-pass filtering function.

13. The eye-tracking system according to claim 7, further comprising a light source for illuminating the face of the user.

14. An eye-tracking system, comprising:
a reflecting mirror configured to:
receive light which travels along a first imaging optical path after reflected by a face of a user;
transmit apart of the light reflected by the face of the user; and
direct another part of the light reflected by the face of the user to travel along a second imaging optical path;
a light-transmitting display module disposed on the second imaging optical path;
an imaging system disposed on a backside of the reflecting mirror and located on an extended path of the first imaging optical path, or on a plane with a depth substantially equal to a depth of the light-transmitting display module and configured to provide an eye image based on the light reflected by the face of the user; and
a processing unit configured to acquire ocular characteristic information of the user by analyzing the eye image.

15. The eye-tracking system according to claim 14, wherein the light-transmitting display module comprises:
a micro display panel for providing a near-eye image; and
a lens configured to form a virtual image by enlarging the near-eye image so as to provide a virtual panoramic space.

16. The eye-tracking system according to claim 14, wherein the light-transmitting display module comprises an optical combiner.

17. The eye-tracking system according to claim 14 herein the ocular characteristic information includes a line of sight, a blink rate, a completeness of blinking, an iris status or a pupil size of the user.

18. The eye-tracking system according to claim 14, wherein the imaging system comprises:
a camera lens coated with an optical film for receiving the light reflected by the face of the user; and
an image sensor configured to provide an eye image based on the light reflected by the face of the user.

19. The eye-tracking system according to claim 18, wherein the optical film provides a cut filtering function or a band-pass filtering function.

20. The eye-tracking system according to claim 14, further comprising a light source for illuminating the face of the user.
